(19) United States
(12) Patent Application Publication
(10) Pub. No.: US 2022/0227969 A1
(43) Pub. Date: Jul. 21, 2022

(54) ROOM TEMPERATURE CURABLE COMPOSITION

(71) Applicant: INVENTO INDUSTRIES, Dehradun (IN)

(72) Inventor: Pranshu JAIN, Dehradun (IN)

(21) Appl. No.: 17/610,457

(22) PCT Filed: May 7, 2020
(86) PCT No.: PCT/IN2020/050410

§ 371 Date: Nov. 11, 2021

(30) Foreign Application Priority Data
May 15, 2019 (IN) 201911019430

(51) Int. Cl. C08K 13/02; C08K 3/26; C08K 3/30; C08K 3/34; C08K 3/36

(52) U.S. Cl. CPC C08K 13/02; C08K 3/26; C08K 3/30; C08K 2003/3045; C08K 3/36; C08K 2003/265; C08K 3/346

(57) ABSTRACT

The present invention discloses a room temperature curable composition, comprising: (a) a polymer; (b) a filler; and (c) a curing catalyst. The polymer is selected from the group consisting of silyl modified polyether, silyl modified polyurethane, silyl terminated polyacrylate, and combinations thereof. The composition of the present invention has sufficiently high plasticity to be moldable by hand in the uncured state.

### FIELD OF THE INVENTION

The present invention relates to a curable composition. More particularly, the present invention relates to a room temperature curable sealant/adhesive composition.

### BACKGROUND OF THE INVENTION

Room temperature vulcanizing moisture curable compositions are well known in the prior art for their use as sealants, adhesives, potting compounds, coatings etc. Of these the most common class of compositions are the ones made with silicone and polyurethane as the base polymer.

According to EP0575863B1, the moisture curable silicone compositions have various advantages like that of adhesiveness at room temperature, resistance to cure inhibition by contaminants present in the curing environment, short cure time, long-term storage stability as a single-package composition, and development of cure by simply standing in the atmosphere. As a result of these features, moisture curable compositions are widely used as adhesives, coatings, and sealants.

These compositions are generally available in the form of liquids, pastes or gels which makes them very sticky and messy. This results in difficulty in manual application as the material cannot be manipulated by the applicator's hands thus limiting their application. Moreover, they require special tools like caulking guns or pumping equipment to dispense them, dissuading the end user from using them.

To overcome these limitations, putty like compositions were developed in the prior art. Of these, the most widely used are the ones made of epoxy polymer as base. US20050032938A1 discloses an epoxy putty which is non-sensitizing to user's hands. U.S. Pat. No. 6,420,458B1 discloses an anchoring adhesive based on epoxy polymer in putty form.

The problems with epoxy putty compositions are that they set into hard as rock like material which is not flexible at all. This limits their application to a large extent as they cannot be used as sealing compounds, applications where vibrations are expected, applications where flexibility is required like repairing rubber parts, or flexible pipes. Also, the user needs to mix and knead the two parts in his hands, slowing the application process. One more major disadvantage is that there is no easy way for removal of the compound and mostly results in damaging the substrate.

US20060142472 discloses a silicone rubber adhesive film with high plasticity and excellent handling by the user. The biggest limitation for these compositions is that they need to be heated in an oven at 130° C. for 30 min. U.S. Pat. No. 7,434,812B2 discloses non curable silicone putty with non-staining properties to be used as a gap filler and water proof seal for components in bath and kitchen.

Formulations based on room temperature vulcanizing silicones and non-curable silicones suffer from significant drawbacks. These types of compositions do not work well on porous substrates, cannot be used on wet or damp surfaces and cannot be applied underwater. They are also not paintable and have low tear resistance and low green strength. Also, they are not recommended for prolonged water immersion or areas where staining might be an issue.

Another class of polymers, hybrid polymers, also known as Silane-terminated polymers combine the advantages of a polyurethane or polyether backbone and silane-based curing mechanism resulting in a highly versatile polymer with excellent cohesive strength and adhesion properties. They cover the complete application range from low modulus sealants up to structural adhesives.

The most important types of hybrid polymers that are used as sealants/adhesives are MS polymers (silyl-modified polyethers) and SPUR polymers (silyl-modified polyurethanes). They have closely associated chemistry and many common features. Because of the similarity of their polymer backbones, collectively these polymers are sometimes referred to as silyl-terminated oligomers. The less commonly known type is Silyl modified Polyacrylate which combines the properties of acrylic backbone with silane functionality. Collectively they are termed as Hybrid polymers. However, formulations based on hybrid polymers are known only in the form of liquids, gels, or thixotropic pastes, making them incapable of being manipulated and shaped by the user because of the aforestated reasons.

Hence, there exists a need in the art to develop a hand moldable composition that can overcome the stated drawbacks of the prior art.

### OBJECTIVE OF THE INVENTION

The main objective of the present invention is to resolve the stated problems in the prior art.

Another objective of the present invention is to provide a room temperature curable sealant/adhesive composition that is sufficiently plastic in the uncured state to be moldable by hand.

Yet another objective of the present invention is to provide a room temperature curable sealant/adhesive composition that does not require special tools to be molded into different forms.

Yet another objective of the present invention is to provide a room temperature curable composition which can be applied underwater and can cure & adhere underwater.

Yet another objective of the present invention is to provide a room temperature curable composition having higher green strength.

Still another objective of the present invention is to provide a hand moldable room temperature curable sealant/adhesive composition having numerous advantages such as paintability, no damage to substrate upon removal, excellent adhesion on damp and porous surfaces, etc.

### SUMMARY OF THE INVENTION

The inventors of the present invention have found that when hybrid polymers are formulated to a sufficiently high plasticity as an uncured substance; the resulting material can be used as a hand moldable sealant/adhesive with numerous benefits over compositions disclosed in the prior art.

In accordance with an aspect of the invention, there is provided a room temperature curable composition, comprising:
a. a polymer;
b. a filler; and
c. a curing catalyst;
   wherein the polymer is selected from the group consisting of silyl modified polyether, silyl modified polyurethane, silyl terminated polyacrylate, and combinations thereof; and wherein said composition has sufficiently high plasticity to be moldable by hand in the uncured state.

The above room temperature curable composition comprises:
a. the polymer in an amount of 20 to 80%;
b. the filler in an amount of 15 to 80%;
c. the curing catalyst in an amount of 0.05 to 4%; and optionally
d. other components selected from the group consisting of adhesion promoters, reinforcing fibers, fragrances, plasticizers, pigments and combinations thereof.

Preferably, the compositions of the present invention comprise:
a. the polymer in an amount of 30 to 70%;
b. the filler in an amount of 25 to 70%; and
c. the curing catalyst in an amount of 0.1 to 2%.

The Plasticity of the composition ranges between 120 to 800, 150 to 400, and preferably between 180 to 300.

Polymers useful in the present invention include:
a. a modified silyl (MS) polymer having formula:

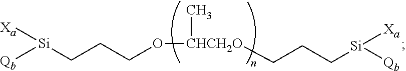

wherein a+b=3 and a is 1, 2 or 3, Q is a monovalent hydrocarbon radical, each X is independently a hydrolysable group selected from the group consisting of methoxy, acetoxy, and oxime;
b. a silyl modified polyurethane; and
c. a silyl terminated polyacrylate having formula:

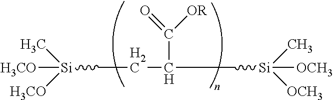

The intumescent filler comprises an intumescent catalyst, a carbonific and a spumific.

Preferably, the intumescent filler is present in an amount of 15 to 50% and wherein the intumescent filler is selected from the group of expandable graphite, alkali metal silicates, vermiculite, and gas filled microspheres.

In accordance with another embodiment, the curing catalyst is selected from the group consisting of organic tin compounds like dibutyltin dilaurate, dibutyltin dioctoate, dibutyltin diacetate, dioctyltin dilaurate; organometallic compounds such as zinc naphthenate, zinc 2-ethyloctoate; amine compounds and aminosilanes like 3-aminopropyltriethoxysilane, 3-aminopropyltrimethoxysilane, and N-β-(aminoethyl)-γ-aminopropyltrimethoxysilane, dialkylhydroxylamines, guanidyl containing silanes, and combinations thereof.

In accordance with yet another embodiment, the reinforcing fibers are present in an amount of 0 to 20% and are selected from the group consisting of glass fibers, carbon fibers, aramid fibers, boron fibers, cellulose fibers, nylon fibers and combinations thereof.

In accordance with still another embodiment, the composition comprises an adhesion promoter, wherein the adhesion promoter is present in an amount between 0.1 and 2 percent and wherein the adhesion promoter is a silane coupling agent having a functional group selected from amino, mercapto, epoxy, carboxyl, and vinyl group.

In accordance with still yet another embodiment the filler comprises barium sulfate, wherein the concentration of barium sulfate is between 5 and 35%. The composition of the present invention is in the form of putty in uncured state.

Compositions of the present invention are hand-moldable, self-supporting, non-tacky to users' hands, and have a clay like consistency. The shore A hardness ranges between 50 and 95, 60 and 85, and preferably between 65 and 75.

The composition of the present invention can also cure and adhere underwater, wherein the difference in adhesive strength of the underwater cured composition and air cured composition is insignificant or less than or equal to 10%.

Said composition has a lap shear green strength of greater than 0.018 N/mm². Preferably, the lap shear green strength is less than 0.07 N/mm². Preferably the composition has a tensile strength of between 2 MPa to 7 MPa, an elongation between 100 and 250%, an adhesive lap shear strength of more than 1.20 MPa and a modulus between 2 and 11 MPa.

In accordance with another aspect of the invention, there is provided a process for preparing said composition comprising mixing the polymer, filler, catalyst and other components in the absence of moisture, wherein;
a. the polymer is present in an amount of 20 to 80%;
b. the filler is present in an amount of 15 to 80%;
c. the curing catalyst is present in an amount of 0.05 to 4%; and optionally
d. other components are selected from the group of adhesion promoters, reinforcing fibers, fragrances, plasticizers, pigments or combinations thereof.

In accordance with an embodiment, the composition is in the form of a putty, is packaged in essentially moisture free container and all the ingredients are contained in a single container. The term “essentially moisture free” refers to a concentration of water that does not lead to premature curing of the composition of the present invention on storage.

In accordance with an embodiment of the invention, the polymer and the curing catalyst are both provided in a putty form and are placed in separate containers, and wherein the contents of the container containing the polymer and the container containing the catalyst are mixed together by the user prior to using the room temperature curable composition.

During the process for preparing the composition of the present invention, the filler is added till the composition attains a plasticity in the range of 120 to 800.

In accordance with yet another aspect of the invention there is provided a kit, comprising two containers, a first container and a second container, a polymer, a filler, a catalyst and other components stored in said containers, wherein the polymer and the catalyst are premixed with filler to form putty and are placed in different containers, and wherein the room temperature curable composition is prepared prior to use of said composition by mixing the putty of the first container and the putty of the second container; said room temperature curable composition, comprising:
a. the polymer in an amount of 20 to 80%;
b. the filler in an amount of 15 to 80%;
c. the curing catalyst in an amount of 0.05 to 4%; and optionally
d. other components selected from the group consisting of adhesion promoters, plasticizers, reinforcing fibers, fragrances, pigments and combinations thereof;
   wherein the uncured composition has a plasticity in the range of 120 to 800, preferably 150 to 400.

### DETAILED DESCRIPTION OF THE INVENTION

Discussed below are some representative embodiments of the present invention. The invention in its broader aspects is not limited to the specific details and representative methods. Illustrative examples are described in this section in connection with the embodiments and methods provided.

It is to be noted that, as used in the specification, the singular forms “a,” “an,” and “the” include plural referents unless the context clearly dictates otherwise. Thus, for example, reference to a composition containing “a compound” includes a mixture of two or more compounds. It should also be noted that the term ‘“or” is generally employed in its sense including “and/or” unless the content clearly dictates otherwise.

The expression of various quantities in terms of “%” or “% w/w” means the percentage by weight of the total solution or composition unless otherwise specified.

All cited references are incorporated herein by reference in their entireties. Citation of any reference is not an admission regarding any determination as to its availability as prior art to the claimed invention.

The present invention, in all its aspects, is described in detail as follows:

Sealants are defined as substances capable of attaching to at least two surfaces, thereby, filling the space or opening between them to provide a barrier or protective coating.

Adhesives are defined as substances capable of holding at least two surfaces together in a strong and permanent manner.

Adhesives and sealants are often considered together because they both adhere and seal, both must be resistant to their operating environments, are often made of similar materials, and they are sometimes used in similar applications. Therefore, the distinction between adhesives and sealants is not always very clear. Sealants are great for air and water tight spaces and should not be used as primary bonding agent as they are subjected to creep under load. Most sealants are adhesives but their primary function is to seal a joint, with adhesion merely being one important property. Adhesives on the other hand have more power for holding and bonding and thus are more rigid and durable than sealants. However, some materials can fulfill requirements of both sealants and adhesives, and these are termed adhesive-sealants.

The terms “sealant” or “adhesive” used herein mean the same thing and can be used interchangeably.

Traditionally, silicones and polyurethanes were preferred for the formulations of adhesives and sealants as both can be formulated over a broad range, but each have some significant flaws. Silicones suffer from issues such as non-paintability, less uncured cohesive strength, dirt pickup and staining, not applicable on wet or damp surfaces, inability to cure underwater, and weaker adhesive properties. On the other hand, polyurethanes suffer from drawbacks such as very slow curing rates, poor high temperature resistance, bubbling due to release of carbon dioxide, and very low UV resistance.

The problems stated above necessitated development of sealants/adhesives that could overcome the drawbacks of silicone and polyurethane polymer and have wider applications. This led to the advent of sealants/adhesives made up of hybrid polymers that combine the favorable properties of two or more families of polymeric materials, for example, silicones and polyurethanes. The hybrid polymer obtained by said combination is highly versatile in nature. The combination provides the sealants/adhesive with the high elasticity and rapid curing of silicones and high mechanical strength and paintability of polyurethanes to yield a product that's easy to use and process. Therefore, the product attains beneficial characteristics of both the class of polymers minimizing the drawbacks.

Hybrid polymer-based sealants/adhesives in the form of easily flowable liquids, gels and thixotropic pastes are well known in the art. They are available in collapsible laminated tubes and one-part or two-part cartridges, requiring caulking gun or automatic pumping equipment to extrude them onto a surface to be sealed and/or glued. In the uncured state, they are liquid or viscous, sticking to the user's hands so the option of using one's hands to apply the sealants/adhesives to objects and surfaces is unavailable, this combined with the requirement of special tools for dispensing them restricts their use to professionals and are not popular among daily consumers. These formulations possess lower viscosities for easy extrusion from the cartridges and better workability. Therefore, efforts are always made by the formulators to lower the viscosity of these compositions by adding diluents or plasticizers. These diluents or plasticizers often affect the adhesive properties of the compositions and therefore many attempts were made in the past to reduce the viscosity through other means. US20150203624A1 tried to achieve the same by presenting a new method of making silyl modified polyether with substantially reduced polymer viscosity. In contrast the present invention aims for just the opposite, i.e., increased viscosity of the composition.

The inventors of the present invention have found that a room temperature moisture curing material, formulated to a sufficiently high plasticity as an uncured substance, can be used as a hand moldable sealants/adhesive with numerous advantages such as non-tacky to user's hands and self-supporting, so that it can be easily and accurately applied by the end user and shaped into any form without the material flowing or sagging while still retaining its ability to effectively adhere to different substrates. The compositions of the present invention afford much higher Green Strength resulting in minimal movement between the substrates avoiding use of clamps and frequent correction by the user. The composition being provided in a laminated, moisture proof package requiring the user to just open the package, remove the product with hands, making its application more convenient and quicker.

Accordingly, the inventors have formulated a room temperature curable sealant/adhesive composition, comprising:
a. a polymer;
b. a filler; and
c. a curing catalyst;
   wherein the polymer is selected from the group consisting of silyl modified polyether, silyl modified polyurethane, silyl terminated polyacrylate, and combinations thereof; and wherein said composition has sufficiently high plasticity to be moldable by hand in the uncured state.

Preferably, the room temperature curable sealants/adhesive composition, comprises:
a. the polymer in an amount of 20 to 80%;
b. the filler in an amount of 15 to 80%;
c. the curing catalyst in an amount of 0.05 to 4%; and optionally
d. other components selected from the group consisting of adhesion promoters, reinforcing fibers, fragrances, plasticizers, and pigments;
   wherein the uncured composition is hand-moldable, self-supporting, non-tacky to users' hands, having a clay like consistency and has a plasticity in the range of 120 to 800, 150 to 400 and preferably 180 to 300.

More preferably, the compositions of the present invention comprise:
a. the polymer in an amount of 30 to 70%;
b. the filler in an amount of 25 to 70%; and
c. the curing catalyst in an amount of 0.1 to 2%.

Polymers that are useful in the present invention are selected from one of:
a. modified silyl (MS) polymer having formula:

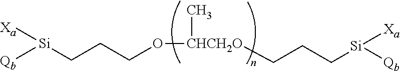

wherein a+b=3 and a is 1, 2 or 3, Q is a monovalent hydrocarbon radical, each X is independently a hydrolysable group selected from the group consisting of methoxy, acetoxy, and oxime;
b. silyl modified polyurethane; and
c. silyl terminated polyacrylate having formula:

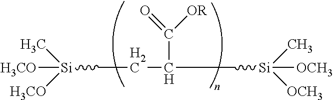

The terms “modified silyl polymer”, “MS polymer”, and “silyl modified polyether” essentially mean the same thing and can be used interchangeably.

Silyl modified polyurethanes can be of the following two types:

A. A silyl terminated polyurethane polymer having at least two urethane linkages per polymer molecule with terminal end-blocking units of the formula

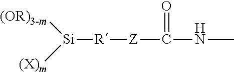

Wherein m is 0, 1 or 2 and X is a lower alkyl radical having 1 to 6 carbon atoms. R is a lower alkyl radical having 1 to 6 carbon atoms, R′ is a divalent bridging group selected from the group consisting of a divalent hydrocarbon radical, a divalent hydrocarbon ether radical and a divalent hydrocarbon amino radical bridging group and wherein Z is a member selected from the group consisting of —S—, and —NR″—, wherein R″ is hydrogen or a lower alkyl radical having 1 to 6 carbon atoms. This is done by reacting isocyanate terminated prepolymer with organofunctional alkoxysilane like secondary amino-organoalkoxysilanes.

B. A silyl terminated polyurethane polymer having at least two urethane linkages per polymer molecule with terminal end-blocking units of the formula:

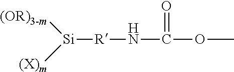

Wherein m is 0, 1 or 2 and X is a lower alkyl radical from 1 to 6 carbon atoms. R is a lower alkyl radical having 1 to 6 carbon atoms, R′ is a divalent bridging group selected from the group consisting of a divalent hydrocarbon radical, a divalent hydrocarbon ether radical and a divalent hydrocarbon amino radical. This is done by reacting hydroxyl terminated prepolymer with an isocyanate-functional alkoxysilane.

One of the main advantages of the hybrid polymers is that their adhesion profile to various substrates is far better than silicones, polyurethanes and other polymers. They do not require the use of primers prior to sealant/adhesive applications. Further, in most cases cleaning of the surface is enough to ensure adhesion between substrates, thereby reducing both cost of materials and cost of application, and avoiding errors during the treatment of the surface before application. This makes them the perfect choice for adhesive formulations,

Moreover, they cure at humidity level higher than 30%, and unlike polyurethanes don't emit CO₂ or any volatile compound which could cause internal bubbles, gassing or blisters in the sealant/adhesive that may reduce the mechanical and cohesive properties of the sealant/adhesive. They possess high elastic recovery; high uncured cohesive strength and the skin formation time is much faster than silicones or polyurethanes resulting in less dirt pickup.

Modified Silyl (MS) polymer has a major advantage over silyl modified polyurethane, that is, it completely eliminates the use of isocyanates. Isocyanates are highly reactive chemicals and are considered hazardous materials to use. Although formulations based on silyl modified polyurethanes are free from isocyanates at the time of application, they still need to be handled during manufacture posing a risk to those involved in manufacturing. Also, MS polymer is considered to be more heat stable as the urethane bond in silyl modified polyurethane can decompose at high temperatures. Therefore, MS polymers are the preferred choice of the two.

An important constituent of the composition of the present invention is a filler. Filler is said to be a solid material capable of changing the physical and chemical properties of materials by surface interaction or its lack thereof and by its own physical characteristics. There are many factors that influence the behavior of fillers in the polymer. The most important include particle size distribution, surface area, shape, oil absorption, color, refractive index, density, hardness, moisture content, thermal stability, modulus, and surface chemistry. Particle size distribution is one of the most important factors. This determines how many particles will be present at a given loading, how close to one another the particles will be, and how much filler surface there will be. Filler must make intimate contact with the elastomer chains in order to reinforce the elastomer compound. This is influenced by the wettability of the filler by the polymer. Adhesion at a polymer-filler interface has been shown to exert a considerable influence on mechanical properties of the compound. Also, fillers that have smaller particles have more contact area available and a higher reinforcement potential. The shape of particles also influences a reinforcement ability of a filler. Planar particles have more surfaces available for contacting the elastomer matrix therefore, having higher reinforcement than spherical particles with similar particle size. Fillers not only influence the properties of the cured polymer but have an equal role in determining the uncured compound characteristics. In a one-part system the filler should be completely dried to prevent premature curing. By one-part system it is meant that the curing catalyst and the polymer are stored in the same container. The term “two-part system” refers to the catalyst and the polymer being in different containers.

Fillers can be divided into three categories—Reinforcing fillers, Semi-Reinforcing Fillers, and Non-reinforcing fillers. Reinforcing fillers include Fumed or Pyrogenic Silica, Precipitated Silica, and Carbon black. Semi-Reinforcing fillers include Precipitated Calcium Carbonate, Talc, Kaolin and Bentonite Clay. Non-reinforcing Fillers include Ground Calcium Carbonate, Barium Sulfate, and Magnesium Silicate. Examples of other fillers that can be used in the present invention include but not limited to ground quartz, magnesium carbonate, titanium dioxide, aluminum silicate, diatomaceous earth, ferric oxide, mica, zinc oxide, ceramic microspheres, glass microbubbles, intumescent filler, waxes like polyamide wax and so forth, each of which can be used either alone or in combination. Fillers can also be treated with coupling or non-coupling treatments to improve their dispersion and compatibility with the polymer. Preferably, the present invention comprises fillers in an amount in the range of 15 to 80% and more preferably in an amount of 25 to 70%.

Preferred reinforcing fillers are fumed silicas, more preferably hydrophobic Fumed Silica. Hydrophobic fumed silicas are fumed silicas treated with hydrophobizing agents to provide a hydrophobic coating. There are silanol groups on the surface of the untreated fumed silica rendering it hydrophilic and with a high tendency to adsorb moisture. These silanol groups are replaced by organic groups rendering the silica hydrophobic. Such silicas have a reduced tendency to adsorb moisture, and thus introduce less moisture into the system, compared to silicas lacking a hydrophobic treatment, thus preventing crepe hardening and providing better shelf life and compound stability. Preferably, hexamethyldisilazane, dimethyldichlorosilane, polydimethylsiloxane, organocyclosiloxanes and other organosilicon compounds are used as hydrophobizing agents. Fumed silica improves the toughness, strength, and elongation of the compound. In general, as the surface area of fumed silica increases, so does thickening and reinforcement. Therefore, it is advantageous to use reinforcing silicas with a specific surface area in the range of 100 to 400 m²/g.

Preferably, the compositions of the present invention contain Barium sulfate in an amount of at least 5%. In a preferred embodiment of the invention the composition contains 5 to 35% of barium sulfate. Barium sulfate is the barium salt of sulfuric acid and is mostly used as a density increaser and a pigment enhancer due to its high whiteness and glaze. Synthetically produced barium sulfate is termed as blanc-fixe and can even be produced at the nanoscale. Even at low loadings high quality blanc-fixe was found out to induce many beneficial effects in the uncured compound. Barium sulfate due to its exceptional oil holding capacity gives a physical structure to the uncured compound. The plasticity and the compositions ability to hold a particular shape is significantly increased by using relatively less amount of filler. This can be due to the fact barium sulfate increases the yield point of the plastic compound more so than other fillers. Plastic materials, the kind of present invention, resist deformation until a certain yield stress is reached, beyond which pseudoplastic flow occurs. This property is very important in the present invention as it prevents the material from flowing or sagging under gravity loads and still allow the user to easily manipulate the material. Care should be taken that the yield point should not be increased to very high as then it would require high yield stress to manipulate the material, therefore the amount of barium sulphate loading should be carefully selected.

The sealants/adhesive composition of the present invention may optionally comprise an intumescent filler in an amount of 15 to 50%. The term “intumescent filler” as used herein refers to those fillers that expand dramatically upon reaching a certain temperature, to many times their original volume and comprise an intumescent catalyst, a carbonific and a spumific. Intumescence process results from a combination of charring and foaming at the surface of the substrate. The result of this process is the formation of a multicellular barrier, thick and non-flammable, which protects the substrate or residual material from heat or flame action. The charred layer acts as a physical barrier which slows down heat and mass transfer between gas and condensed phase.

The intumescent catalyst is a material that contains phosphorous and decomposes at 150° C. to yield phosphoric acid. Non-limiting examples of intumescent catalysts include ammonium polyphosphate (APP), urea phosphates, melamine phosphates, and diammonium phosphates. A carbonific is a material that when reacted with the acid decomposition by-product from the catalyst forms a carbonaceous foamed char at higher temperatures. Typical examples of carbonifics, include but not limited to, mono-, di-, and tri-pentaerythritols; sugar; starches; and polyols. The third necessary ingredient is a spumific, which serves as the blowing agent. On decomposition, a spumific generally releases significant quantities of gas by-product causing foaming. Non-limiting example of spumific includes Melamine, which gives off ammonia at approximately 300° C. Most commonly used intumescent additives are expandable graphite, alkali metal silicates, vermiculite, and gas filled microspheres.

The curing catalyst forms an important constituent of the sealant/adhesive composition of the present invention. Non-limiting examples of the curing catalyst include organic tin compounds like dibutyltin dilaurate, dibutyltin dioctoate, dibutyltin diacetate, dioctyltin dilaurate; organometallic compounds such as zinc naphthenate, zinc 2-ethyloctoate, iron 2-ethylhexoate, cobalt 2-ethylhexoate, cobalt naphthenate; amine compounds and aminosilanes like 3-aminopropyltriethoxysilane, 3-aminopropyltrimethoxysilane, and N-β-(aminoethyl)-γ-aminopropyltrimethoxysilane as well as silanes containing a guanidyl group like tetramethylguanidylpropyltrimethoxysilane, tetramethylguanidylpropylmethyl-dimethoxysilane and so forth, each of which can be used independently or in combination.

Adhesion promoters such as silanes promote many properties of the compound like wet and dry adhesion, mechanical properties, resistance to heat, moisture and other atmospheric factors. Non limiting examples of the silane coupling agents include silane coupling agents having a functional group such as an amino, mercapto, epoxy, carboxyl, and vinyl group. Particularly preferred are aminosilanes like 3-aminopropyltriethoxysilane, 3-aminopropyltrimethoxysilane, and N-β-(aminoethyl)-γ-aminopropyltrimethoxysilane each of which can be used independently or in combination. Preferably, the adhesion promoters are present in an amount in the range of 0.1 to 2%.

Inclusion of water scavenger like vinytrimethoxysilane in the composition is particularly advantageous for storage stability of the compound.

The sealant/adhesive composition of the present invention optionally comprises reinforcing fibers. Preferably, the reinforcing fibers are present in an amount of 0 to 20%. Non-limiting examples of reinforcing fibers include glass fibers, carbon fibers, aramid fibers, boron fibers, cellulose fibers, and nylon fibers. The fiber type, fiber content, fiber aspect ratio, fiber dispersion, fiber-matrix adhesion will all depend on the desired stiffness, strength, and flexibility. Prior to using the fibers in the composition of the present invention, they can be treated with the adhesion promoters to increase the bond with polymer matrix.

Other ingredients which may be added to the sealants/adhesives composition include pigments, dyes, ultraviolet stabilizers, fungicides, plasticizers, heat stabilizers, fire retardants, HALS stabilizers etc.

Since modified silyl (MS) polymers can be blended with other polymers like epoxy, products with even higher mechanical properties can be achieved. Epoxy and MS polymer blend results in a heterogeneous matrix consisting of the epoxy parts functioning as hard segments and elastic MS polymer matrix. This structure can be useful to make sealants/adhesives/coatings which are high in strength but still elastic.

The composition of the present invention is formulated to be a room temperature curable, hand moldable material, non-tacky to user's hands and in the form of putty in the uncured state. This is explained further in detail.

Room temperature curable, as the name implies means a material that can polymerize (cure) at room temperature. There are many types of curing mechanisms for different types of polymers. Some include curing by heat, radiation, chemical additives etc. Hybrid polymers cure by reacting with the moisture in the presence of a catalyst. The hydrolysable group at the end terminal like methoxysilane reacts with water to form silanol liberating methanol, this reaction is termed as hydrolysis. The silanol groups formed then can react with other silanol groups liberating water or react with other methoxysilane groups to liberate methanol thus creating a three-dimensional network and polymerizing. This reaction is termed as condensation. Practically, this is done in two ways either as a one-part system or a two part system. In one-part system all the reactants are mixed and stored in a moisture proof container, then at the time of application the mix is allowed to react with the moisture in the atmosphere and the material starts to cure from outside to inside. This means that the material is not able to cure in very deep sections as the cured material acts as barrier for moisture. This system also requires that no residual water should be present in the system to prevent premature curing. In a two-part system, the polymer and the catalyst are stored in separate containers with sufficient amount of water in one of them. Then at the time of application the two parts are mixed and curing reactions start. This system enables deep section curing as the material cures as a whole and not from outside to inside as is the case in one-part system. This system requires thorough mixing by the user delaying the application process. If not mixed thoroughly it would result in a substandard product. Selection between the one-part system and two-part system is mostly done according to the type of application and the target user. One-part system due to its easier, efficient and faster implementation is the preferred choice for the present invention. Room temperature vulcanizing is particularly important for the present invention as it allows the user to use the product without requiring any special tools or equipment to heat or radiate the product. The cure is completed by simply letting the product stand in the atmosphere.

Putty is defined as a soft material with high plasticity and similar consistency to clay and dough. The same definition applies in the present context. While moldable is defined as to be able to work something into a required shape or form. Therefore, a hand moldable material would mean a material that can be shaped or formed using one's hands which requires the material to be non-sticky and self-supporting so that it can hold the shape without any containment. It should not be confused with LSR or liquid silicone rubber which is also moldable but in a different context. LSR is a two-part platinum-cured elastomer that can be injected into a mold cavity to manufacture a part. It is liquid in consistency and vulcanizes at room temperature. Being a liquid, it flows very easily requiring a cavity to contain the liquid. Therefore, these materials can't be molded or shaped by user's hands as it requires the material that can hold the shape on its own without any containment. Another common moldable material is HTV—high temperature vulcanizing silicone rubber also known as high consistency silicone rubber. HTV contains polymers with a high molecular weight and long polymer chains. HTV has high viscosity and the consistency of putty is very similar to the present invention, therefore is moldable by hand. HTV requires very high temperature for curing and is generally done in specialized ovens. Both have no adhesive properties associated with them and adhesion is considered as a detrimental property for both. Thus, they defeat the very purpose that the present invention tends to achieve.

Tack is referred to as the stickiness of a material and the quality that allows immediate adhesion between two surfaces with a minimum pressure and contact time. Tack is greatly influenced by the wettability of the material which in turn is determined by the balance between the adhesive and cohesive forces of the material. When an adhesive comes in contact with a substrate its ability to wet-out the substrate is determined by the difference in surface energy of the substrate and the adhesive. The surface energy of the substrate should be higher than that of the adhesive to effectively wet-out the substrate by the adhesive. This corresponds to higher tack. Thus, it is required to reduce the free surface energy of the adhesive as low as possible so it can effectively wet-out and adhere all possible substrates. Surface energies around 20 mJ/m² can be easily achieved these days. The aim of the present invention is to provide a material that is non tacky to user's hands so that it can be easily handled but should also be tacky enough to effectively bond with other substrates like glass and metals. This can be achieved due to the fact that free surface energy of human skin is believed to be around 35 mJ/m² much lower than traditional materials like glass and metals which have surface energy in the order of hundreds and thousands. Thus, the present invention is formulated such that its internal cohesive forces are increased to the point that it results in greatly reduced tack to lower energy surfaces like human skin while retaining effective tack to higher energy surfaces. This requires careful selection of the fillers based mostly on their particle size, surface area and surface activity which in combination with viscosity of the polymer will ultimately define the loading percentage of each to obtain the desired properties.

The high cohesive forces also provide the composition with enough backbone to retain the shape and form it's been molded into without any slump or flow. This property reflects the plasticity of the composition. A composition with very low plasticity will be too soft and won't be able to hold its shape and in the present case would also be a little too sticky than desired. A composition with too high plasticity number would be too hard and would require very high forces to mold into different shapes. Since the compound exhibits thixotropic behavior which means that its viscosity decreases with increase in shear rate also known as shear thinning property. In case of thixotropic compositions, the viscosity is recovered to its original value only after a fixed interval of time depending upon the properties of the composition. This behavior is observed with measurement of plasticity also. Compositions just after mixing show much lower plasticity value than plasticity measured after storage. Therefore, to eliminate doubt, all the values of plasticity mentioned (otherwise specified) are the ones measured after at least 3 days of storage.

One of the main properties that affects the mechanical characteristics of the cured composition is the modulus of the polymer. The modulus provides information on the stress-strain behavior of a material. It is equal to the ratio of stress to strain at that instance. Whereas, Modulus of Elasticity also known as Young's Modulus is the ratio of stress to strain within the elastic limit of the material. To say that a material has a high modulus of elasticity basically means that it is rigid. A large amount of force would be needed to deform it. Representation of modulus at 100% strain is a very common practice in the industry. Modulus of the polymer is mostly governed by the length & molecular weight of the pre-polymer chain, the level of branching in the pre-polymer and functionality of the terminal groups. The modulus of the polymer directly affects the modulus of the composition, which in turn affects its softness, tensile strength and elongation at break. High modulus compositions generally show higher tensile strength and lower elongation, attributes required for an adhesive while low modulus compositions generally show lower tensile strength but higher elongation, attributes required by sealants. Sealants with modulus at 100% less than 0.4 MPa are considered as low modulus. These are used in high movement joints like expansion joints in roads and prefabricated concrete parts. They are also used with sensitive substrates. Using high modulus sealants on weak substrates may result in stresses higher than that the substrate can tolerate resulting in cohesive failure of the substrate near the interface. Structural sealants are much higher modulus sealants where some formulations can also be used as effective adhesives, these are marketed as all-purpose formulations. Elastic adhesives generally have an elastic modulus of more than 3 MPa as low movement between the substrates is desirable even at high loads. Modulus of the composition is also affected by the type and loading of the filler as well as the type and amount of the adhesion promoter. Talc due to its planar structure imparts higher modulus than a spherical filler like calcium carbonate. Modulus directly affects the softness of the compound. Preferably, the compositions of the present invention afford tensile strength between 2 MPa to 7 MPa, elongation between 100 to 250% and modulus of elasticity between 2 to 11 MPa.

Softness is measured according to ASTM D-2240 by a Shore A durometer. Higher modulus leads to harder material with a high shore A rating while lower modulus leads to softer materials. The classification between low modulus sealants, structural sealants, and adhesives can also be done based on their softness. Low modulus construction sealants have shore A rating between 15 and 35, Structural Sealant between 30 and 60, and elastic adhesives more than 50. Since the compositions of the present invention are used as a repair material, a cushioning material for sharp objects, for making personalized handgrips, a gap filler and as a craft material, these applications require the material to possess a level of rigidity and stiffness. This limits the maximum softness that a material can attain as a highly soft material would not be able to perform the mentioned task. Therefore, the cured compositions of the present invention must have a shore A rating of at least 50. Preferably, the shore A hardness of the compositions of the present invention is between 50 and 95, 60 and 85, and more preferably 65 and 75.

Green strength is defined as the initial bond strength immediately after the bond is made. High green strength prevents any unnecessary movement between the bonded substrates and in some case avoid the use of clamps or reduce clamping force. This saves time as no buffer for handling strength is required which results in productivity enhancements and faster assembly. Surprisingly, it was found out that even after reducing the tack to the level that the composition of the present invention can be hand molded, because of the higher cohesive forces the said composition showed much higher level of green strength than any other prior art, around 8 to 10 times the green strength observed for liquid paste formulations specially designed for high tack and high green strength. Preferably, the composition of the present invention affords a lap shear value, which is a measure of the green strength of at least 0.018 N/mm². More preferably, the lap shear value as a measure of the green strength is less than 0.07 N/mm².

To test the underwater curability and adherence, lap shear strength tests on stainless steel specimens according to ASTM D1002 were conducted where half the samples in each formulation were applied underwater and left to cure underwater for 3 days and other half were applied as usual in the air and were also left to cure for 3 days. Complete cure and excellent adhesion properties were observed in each case. More so, the difference in strength between the air cured samples and water cured samples was found to be insignificant. This indicates that the present invention is not only good for wet or damp surfaces but is an exceptional choice even for underwater applications. Preferably, the adhesive lap shear strength afforded by the compositions of the present invention is greater than 1.20 MPa.

Flexibility combined with excellent underwater adhesion will hugely benefit irrigation, plumbing, and marine applications like to repair boats, repair inflatables like pool toys, repair or modify patio furniture, apply to pool tiles or repair leaks, in spas or steam rooms and fix leaks in fittings, hoses or pipes.

One of the important applications of the present invention is as a repair material for holes or leaks in a PVC or metal pipeline or hose in households and buildings. Traditional repair compounds require the flow of the water to be stopped as it would not have high wet adhesion and high enough green strength and integrity to bear the force applied from high water discharge, just after application. Therefore, a compound which enables the user to repair the damage without blocking the water will be very convenient and productive for the user. The present invention due to exceptional wet adhesion and vastly higher green strength and integrity can bear much larger forces applied by the water discharge enabling the user to repair the leak without blocking the water in most residential and some commercial cases.

In accordance with another aspect of the invention, all formulation ingredients are contained in a single package (Single package system or one-part system). Depending on the curing chemistry, the sealants/adhesives composition is packaged in a moisture impermeable container to prevent curing within the package. For moisture-induced cure systems, a water scavenger is introduced in the formulation. The water scavenger chemically dries the sealant/adhesive composition by reacting with any surface-adsorbed water. During storage of the finished product, the scavenger maintains the shelf stability of the unopened container by reacting with any water diffusing into the package. Such a one-part system can also be in the form of a kit comprising a single container containing all the components of the room-temperature curable composition.

In accordance with a further embodiment of the invention, the ingredients polymer and curing catalyst are placed in separate containers both mixed with suitable amount of filler and other ingredients to form a putty. This approach makes the ingredients in the individual containers non-curable, unless they are mixed. Suitable amount of water may be incorporated with the curing catalyst to ensure in depth cure. Such a system is referred to as a two-part system.

The two-part system may also be in the form of a kit, comprising a first container and a second container, wherein a polymer, filler, catalyst and other components stored in said containers, wherein the polymer and catalyst are premixed with filler to form putty and are placed in different containers, and wherein the room temperature curable composition is prepared just prior to use of said composition by mixing the putty of the first container and the putty of the second container.

In accordance with yet another aspect of the invention, there is provided a process for preparing the sealants/adhesives composition for the single package system. This process comprises mixing the polymer, filler, curing catalyst, and other components in the absence of moisture, wherein;
a. the polymer is present in an amount of 20 to 80%;
b. the filler is present in an amount of 15 to 80%;
c. the curing catalyst is present in an amount of 0.05 to 4%; and optionally
d. other components are selected from the group of adhesion promoters, reinforcing fibers, fragrances, plasticizers, pigments or combinations thereof.

In accordance with still another aspect of the invention, there is provided a process for preparing the sealants/adhesives composition from the two-package or two-part system, wherein the polymer and the curing catalyst are stored separately in the form of putty. For example, the process comprises the step of mixing the contents of container A, which comprises the polymer, and container B, which comprises the curing catalyst, to form the sealant/adhesive composition of the present invention, just prior to the use of the sealant/adhesive composition.

The compositions of the present invention may be used in myriad ways. There are many cases in which products and equipment of all kinds could be improved for specific needs of individual consumers if they could easily add an (optionally) permanent, durable, flexible and waterproof rubber padding to their products and equipment. Such a padding might be applied to form a protective and reinforcing layer like at the split of a charging cable, to dampen noise or vibration like as a door stopper, to add grips to a surface or custom handgrips on a tool like a hammer, to form a soft layer for cushioning like on the jaws of pliers, to insulate from cold or hot surfaces like handles of cookware. Added padding can also increase safety by covering and protecting sharp or dangerous parts of products, equipment and machinery. A key advantage of the composition of the present invention is that it can be formed into any shape or size over/around any object thus allowing the user to modify, improve and customize the object according to their personal needs. Different types of texture, embossing, or patterns can be easily formed on the surface giving the user design flexibility. Another key advantage is that if the user is not satisfied with the modification, he/she can simply cut and pry the material with a sharp knife without damaging the substrate. The material can be used as a versatile craft material like polymer clay used to create 3-d paintings and structures with many advantages over it like flexibility and ability to cure in air without the need of oven. The composition is inherently an adhesive with good sealing properties so it can be used for most of the traditional adhesive applications as well as sealing various types of joints with the exception of expansion or movement joints. So, it can be used as a seal around sinks and other fittings, in joints between similar or dissimilar materials, and other static joints. A major use of the composition is as a repair material. The broad adhesion profile combined with flexibility and underwater applicability enables the user to repair wide array of products from flexible parts like fridge rubber door seals or textiles like leather to plastics, metals or ceramics. The compositions can also be used as filler material to fill holes or dents in various substrates including porous substrates like stones, bricks, and wood.

The ability to provide the user with customized hand grip can give an edge to various tool manufactures. This can be brought about by compression molding the composition of the present invention over the tool or equipment and then sealing the material in moisture proof packaging. The user will have to just remove the packaging, dip his hands in soap solution and grasp the tool in the required position deforming the material into the shape of the hand. High adhesion and green strength will ensure good bond between the materials leading to a custom flexible and durable grip.

The present invention is more particularly described in the following examples that are intended as illustrations only, since numerous modifications and variations within the scope of the present invention will be apparent to those skilled in the art. Unless otherwise noted, all parts, percentages, and ratios reported in the following examples are on a weight basis, and all reagents used in the examples were obtained or are available from the chemical suppliers.

### EXAMPLES

The following examples illustrate the basic methodology and versatility of the present invention.

The following tests were performed

PLASTICITY—The plasticity was determined by the standard ASTM D926 also known as Parallel Plate Method. In this test, a sample in the shape of a cylinder with 16 mm diameter and 10 mm height is placed between two sheets of non-stick parchment paper which is then placed between two parallel plates which are not less than 10 mm in thickness and 40 mm in diameter and compressed with a constant load of 49 N for 3 min. Plasticity number then is calculated by multiplying the final compressed height in mm with 100. The plasticity was measured after at least 3 days of storage and the curing catalyst and adhesion promoter was omitted to prevent cure during test. From the results table it is evident that the plasticity values of the compositions of the present invention is significantly greater compared to prior art (comparative example) compositions.

HARDNESS—The samples were prepared and tested according to the standard ASTM D2240 using a Type A durometer. The samples were all allowed to cure for at least 3 days to ensure complete cure. The measure of hardness in terms of shore A values is illustrated in the results table.

TENSILE STRENGTH, ELONGATION & MODULUS OF ELASTICITY—The samples were formed into 2 mm thick sheets and allowed to cure for 3 days. The tests were performed according to ASTM D412 (Test Method A). The values obtained for tensile strength, elongation and modulus of elasticity are illustrated in the results table.

ADHESIVE STRENGTH—Adhesive strength was determined in Shear Strength between two bonded stainless-steel plates according to ASTM D1002. The material thickness was fixed at 1 mm and half the samples were placed in air with 50% RH and other half underwater and were allowed to cure for 3 days in both cases to ensure thorough cure. The values of lap shear which is a measure of the adhesive strength on curing in air and underwater lap shear which a measure of the adhesive strength on curing underwater are illustrated in the results table. The differences between the two values are illustrated in the results table under the column heading “difference”. From values illustrated under the column heading “difference”, it is evident that the differences between the values of underwater lap shear and lap shear for the compositions of the present invention are insignificant compared to the differences between those values for prior art (comparative) compositions. Preferably, compositions of the present invention afford a difference of less than 10%.

GREEN STRENGTH—The green strength was also measured in lap shear according to standard ASTM D1002 but the rate of loading was increased to 20 mm/min. The material was applied with 1 mm thickness and no cure time was given. From the results table, it is evident that the green strength values for the compositions of the present invention are significantly greater compared to those for prior art (comparative) compositions.

The following raw materials were sourced

Polymer

Kerilon 668T—High Modulus Silane terminated Polyether with 48000 MPas viscosity supplied by Risun Polymer.

Kerilon 380—Medium Modulus Silane terminated Polyether with 42000 MPas viscosity supplied by Risun Polymer.

Kerilon 3632T—Low Modulus Silane terminated Polyether with 30000 MPas viscosity supplied by Risun Polymer.

Fumed Silica

CAB-O-SIL TS 610—Hydrophobic Fumed Silica with a surface area of 125 m²/gm supplied by Cabot Corporation.

HDK H15—Hydrophobic Fumed Silica with a surface area of 120 m²/gm supplied by Wacker.

Precipitated Silica

UNISIL NK-7—Hydrophilic Precipitated Silica with a surface area of 300 m²/gm supplied by MLA Group of Industries.

Precipitated Calcium Carbonate

KC-1 Super—With D50 particle size 4 μm and 8 m²/gm surface area, supplied by Kunal Calcium Limited.

KC-11—With 20 m²/gm surface area, supplied by Kunal Calcium Limited.

EXTRAFINE—With D50 particle size 5 μm, supplied by Yamuna Calcium Pvt Limited.

Barium Sulfate

Basofix P—With D50 particle size 1 μm, supplied by 20 Microns Limited.

Talc

Micron Talc 2 μm—With D50 particle size 3 μm, supplied by 20 Microns Limited.

500 Mesh—Supplied by Anand Talc.

Catalyst

Dibutyltin Dilaurate (DBDTL)—Supplied by Nexus Polychem.

Dibutyltin Diacetate—Supplied by Nexus Polychem.

Water Scavenger

YAC-V171—Vinyltrimethoxy Silane, supplied by Lanya Chemical (INDIA) Pvt. Ltd.

Adhesion Promoter

YAC-A111—3-Aminopropyltriethoxy Silane, supplied by Lanya Chemical (INDIA) Pvt. Ltd.

The compositions of the present invention can be prepared by using any high viscosity mixture with high shear mixing and preferably with vacuum system to remove entrapped air and prevent exposure to moisture.

Particularly preferred are kneaders like Sigma Blade Mixer, and Co-rotating Twin Screw Extruder.

Example 1
Risun Polymer 3632 T-44%
Fumed Silica CAB-O-SIL TS 610-8.8%
Ppt Calcium Carbonate KC 1-45.2%
Water Scavenger YAC-V171-1%
Adhesion Promoter YAC-A111-0.5%
Catalyst DBDTL-0.5%

Example 2
Risun Polymer 380 T-41%
Fumed Silica CAB-O-SIL TS 610-8%
Ppt Calcium Carbonate EXTRAFINE-49%
Water Scavenger YAC-V171-1%
Adhesion Promoter YAC-A111-0.5%
Catalyst DBDTL-0.5%

Example 3
Risun Polymer 380 T-41%
Fumed Silica CAB-O-SIL TS 610-8%
Micron Talc 2 μm-49%
Water Scavenger YAC-V171-1%
Adhesion Promoter YAC-A111-0.5%
Catalyst DBDTL-0.5%

Example 4
Risun Polymer 380 T-71%
Fumed Silica HDK H15-27%
Water Scavenger YAC-V171-1%
Adhesion Promoter YAC-A111-0.5%
Catalyst DBDTL-0.5%

Example 5
Risun Polymer 668 T-43%
Fumed Silica HDK H15-6.7%
500 Mesh Talc-57.3%
Water Scavenger YAC-V171-1%
Adhesion Promoter YAC-A111-0.5%
Catalyst Dibutyltin Diacetate-0.5%

Example 6
Risun Polymer 380 T-44%
Fumed Silica CAB-O-SIL TS 610-9%
Ppt Calcium Carbonate KC 1 Super-45%
Water Scavenger YAC-V171-1%
Adhesion Promoter YAC-A111-0.5%
Catalyst DBDTL-0.5%

Example 7
Risun Polymer 380 T-44.5%
Fumed Silica CAB-O-SIL TS 610-9%
Ppt Calcium Carbonate KC 11-44.5%
Water Scavenger YAC-V171-1%
Adhesion Promoter YAC-A111-0.5%
Catalyst DBDTL-0.5%

Example 8
Risun Polymer 380 T-21%
Risun Polymer 3632 T-21%
Fumed Silica CAB-O-SIL TS 610-9.8%
Ppt Calcium Carbonate KC 1-36.4%
Barium Sulphate Basofix P-9.8%
Water Scavenger YAC-V171-1%
Adhesion Promoter YAC-A111-0.5%
Catalyst DBDTL-0.5%

Example 9
Risun Polymer 3632 T-69.5%
Fumed Silica CAB-O-SIL TS 610-14%
Precipitated Silica UNISIL NK7-14%
Water Scavenger YAC-V171-1%
Adhesion Promoter YAC-A111-0.5%
Catalyst DBDTL-1%

### COMPARATIVE EXAMPLES

Fix ALL High Tack—Hybrid Polymer based adhesive sealant in the form of a high viscosity thixotropic paste supplied by Soudal.

SoudaSeal 665—MS Polymer based elastic adhesive in the form of a thixotropic paste supplied by Soudal.

MSeal Super—Epoxy putty adhesive supplied by Pidilite.

Dowsil GP Silicone Sealant—Acetoxy curing general purpose silicone sealant supplied by DOW.

### RESULTS TABLE

| | Tensile | | Modulus of | Plasticity | Shore | Lap | Underwater | | Green |
|---|---|---|---|---|---|---|---|---|---|
| Example | Strength | Elongation | Elasticity | Value | A | shear | Lap Shear | Difference | Strength |
| Exp 1 | 2.5 MPa | 165% | 2.16 MPa | 155 | 60 | 1.4 MPa | 1.37 MPa | 2.14% | 0.025 |
| | | | | | | | | | N/mm² |
| Exp 2 | 3.46 MPa | 138% | 5.7 MPa | 185 | 75 | 2.3 MPa | 2.45 MPa | 6.12% | 0.038 |
| | | | | | | | | | N/mm² |
| Exp 3 | 4.9 MPa | 100% | 11 MPa | 125 | 76 | 1.41 MPa | 1.29 MPa | 8.51% | 0.019 |
| | | | | | | | | | N/mm² |
| Exp 4 | 2.96 MPa | 176% | 2.9 MPa | 237 | 64 | 1.31 MPa | 1.25 MPa | 4.58% | 0.035 |
| | | | | | | | | | N/mm² |
| Exp 5 | 6.94 MPa | 63% | 19.5 MPa | 188 | 88 | 1.54 MPa | 1.49 MPa | 3.25% | 0.028 |
| | | | | | | | | | N/mm² |
| Exp 6 | 3.74 MPa | 142% | 5 MPa | 180 | 74 | 1.64 MPa | 1.61 MPa | 1.83% | 0.037 |
| | | | | | | | | | N/mm² |
| Exp 7 | 3.43 MPa | 125% | 6.2 MPa | 210 | 77 | 1.89 MPa | 1.8 MPa | 4.76% | 0.034 |
| | | | | | | | | | N/mm² |
| Exp 8 | 3.4 MPa | 153% | 3.4 MPa | 263 | 71 | 1.98 MPa | 2.1 MPa | 5.71% | 0.042 |
| | | | | | | | | | N/mm² |
| Exp 9 | 2.31 MPa | 205% | 1.25 MPa | 223 | 53 | 1.24 MPa | 1.21 Mpa | 2.42% | 0.033 |
| | | | | | | | | | N/mm² |
| Soudaseal | 2.7 MPa | 162% | 2.6 MPa | 80 | 67 | 1.52 MPa | 1.2 MPa | 21.1% | 0.0031 |
| 665 | | | | | | | | | N/mm² |
| Fix All High | 3.05 MPa | 360% | 2.3 MPa | 90 | 65 | 1.61 MPa | 1.23 MPa | 23.6% | 0.0047 |
| Tack | | | | | | | | | N/mm² |
| Epoxy Putty | 6.4 MPa | 7% | 465 MPa | 196 | 100+ | 2.54 MPa | 2.35 MPa | 7.5% | 0.009 |
| Mseal Super | | | | | | | | | N/mm² |
| GP Silicone | 1.2 MPa | 520% | 0.36 MPa | 40 | 18 | 0.50 MPa | 0.03 MPa | 94% | 0.0018 |
| Sealant | | | | | | | | | N/mm² |

All the examples were examined manually by hands to check the tackiness and moldability. Examples 1 to 9 were in the form of putty and showed adequate amount of tackiness and good moldability by hand, except for Example 3, which, although in putty form, was found to be a slightly difficult to mold with hands due to excessive tack and tendency to leave a bit of residue on hands. This composition was at the bottom end of the spectrum of desirable plasticity. All the comparative examples except epoxy putty, were in the form of thick liquids with very high tack and were impossible to mold with hands.

All the examples 1 to 9 showed a skin forming time between 10 to 15 min with a cure depth of 3 to 4 mm after 24 hours when cured at 50% RH at 23° C.

The invention may be embodied in other specific forms without departing from the spirit or essential characteristics thereof. The present embodiments are therefore, to be considered in all respects as illustrative and not restrictive.

What is claimed is:

1. A room temperature curable composition, comprising:
a. a polymer;
b. a filler; and
c. a curing catalyst;
wherein the polymer is selected from the group of silyl modified polyether, silyl modified polyurethane, silyl terminated polyacrylate, or combinations thereof; and wherein said composition has sufficiently high plasticity to be moldable by hand in an uncured state.

2. The room temperature curable composition as claimed in claim 1, comprising:
a. a polymer in an amount of 20 to 80%;
b. a filler in an amount of 15 to 80%;
c. a curing catalyst in an amount of 0.05 to 4%; and optionally
d. other components selected from the group of adhesion promoters, reinforcing fibers, fragrances, pigments or combinations thereof.

3. The room temperature curable composition as claimed in claim 2, wherein:
a. the polymer is present in an amount of 30 to 70%;
b. the filler is present in an amount of 25 to 70%; and
c. the curing catalyst is present in an amount of 0.1 to 2%.

4. The composition as claimed in claim 1, wherein the composition has plasticity between 120 to 800.

5. The composition as claimed in claim 1, wherein the composition has plasticity between 150 to 400.

6. The composition as claimed in claim 1, wherein the composition has plasticity between 180 to 300.

7. The composition as claimed in claim 1, wherein the polymer is any one of:
a. modified silyl (MS) polymer having formula 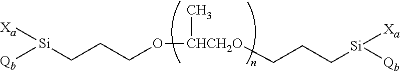
wherein a+b=3 and a is 1, 2 or 3, Q is a monovalent hydrocarbon radical, each X is independently a hydrolysable group selected from the group of methoxy, acetoxy, or oxime;
b. silyl modified polyurethane; or
c. silyl terminated polyacrylate having formula:

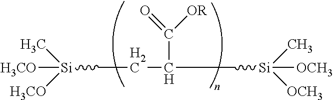

8. The composition as claimed in claim 1, wherein the filler is selected from the group of silica, fumed silica, precipitated silica, ground quartz, calcium carbonate, magnesium carbonate, kaolin and bentonite clays, talc, titanium dioxide, aluminum silicate, diatomaceous earth, ferric oxide, carbon black, zinc oxide, ceramic microspheres, glass microbubbles, barium sulfate in concentration between 5 to 35%, intumescent filler, waxes or combinations thereof, and wherein the intumescent filler comprises an intumescent catalyst, a carbonific and a spumific, and wherein the intumescent filler is present in an amount of 15 to 50% and wherein the intumescent filler is selected from the group of expandable graphite, alkali metal silicates, vermiculite, and gas filled microspheres.

9. (canceled)

10. (canceled)

11. The composition as claimed in claim 1, wherein the curing catalyst is selected from the group of organic tin compounds like dibutyltin dilaurate, dibutyltin dioctoate, dibutyltin diacetate, dioctyltin dilaurate; organometallic compounds such as zinc naphthenate, zinc 2-ethyloctoate; amine compounds and aminosilanes like 3-aminopropyltriethoxysilane, 3-aminopropyltrimethoxysilane, and N-β-(aminoethyl)-γ-aminopropyltrimethoxysilane, dialkylhydroxylamines, guanidyl containing silanes, or combinations thereof.

12. The composition as claimed in claim 2, wherein the reinforcing fibers are present in an amount of 0 to 20% and are selected from the group of glass fibers, carbon fibers, aramid fibers, boron fibers, cellulose fibers, nylon fibers or combinations thereof.

13. The composition as claimed in claim 2, wherein the composition comprises an adhesion promoter, wherein the adhesion promoter is present in amount between 0.1 to 2 percent, and wherein the adhesion promoter is a silane coupling agent having a functional group selected from amino, mercapto, epoxy, carboxyl, and vinyl group.

14. (canceled)

15. (canceled)

16. (canceled)

17. (canceled)

18. The composition as claimed in claim 1, wherein the composition in the uncured state is in the form of putty and is hand-moldable, self-supporting, non-tacky to users' hands, and has a clay like consistency.

19. (canceled)

20. The composition as claimed in claim 1, wherein said composition has shore A hardness between 50 and 95, or between 60 and 85, or between 65 and 75.

21. (canceled)

22. (canceled)

23. The composition as claimed in claim 1, wherein said composition can cure and adhere underwater, wherein the difference in adhesive strength of the underwater cured composition and air cured composition is less than or equal to 10%.

24. (canceled)

25. The composition as claimed in claim 1, wherein said composition has a lap shear green strength of greater than 0.018 N/mm², or has a lap shear green strength of less than 0.07 N/mm².

26. (canceled)

27. The composition as claimed in claim 1, wherein said composition has a tensile strength of between 2 MPa to 7 MPa, and has an elongation between 100 and 250%.

28. (canceled)

29. The composition as claimed in claim 1, wherein said composition has an adhesive lap shear strength of more than 1.20 MPa, and has a modulus between 2 and 11 MPa.

30. (canceled)

31. A process for preparing a room temperature curable composition, comprising mixing a polymer, a filler, a curing catalyst and other components in the absence of moisture wherein:
a. the polymer is present in an amount of 20 to 80%;
b. the filler is present in an amount of 15 to 80%;
c. the curing catalyst is present in an amount of 0.05 to 4%; and optionally
d. other components are selected from the group of adhesion promoters, reinforcing fibers, fragrances, pigments or combinations thereof;
wherein the composition in an uncured state has a plasticity in the range of 120 to 800, preferably 150 to 400, and more preferably 180 to 300.

32. The process as claimed in claim 18, wherein the composition is in the form of a putty, is packaged in essentially moisture free container and all the ingredients are contained in a single container.

33. (canceled)

34. (canceled)

35. A kit, comprising two containers, a first container and second container, a polymer, filler, catalyst and other components stored in said containers, wherein the polymer and catalyst are premixed with filler to form putty and are placed in different containers, and wherein the room temperature curable composition is prepared just prior to use of said composition by mixing the putty of the first container and the putty of the second container; said room temperature curable composition, comprising:
a. a polymer in an amount of 20 to 80%;
b. a filler in an amount of 15 to 80%;
c. a curing catalyst in an amount of 0.05 to 4%; and optionally
d. other components selected from the group of adhesion promoters, reinforcing fibers, fragrances, pigments or combinations thereof;
wherein the composition in an uncured has a plasticity in the range of 120 to 800, preferably 150 to 400, and more preferably 180 to 300.
